(19) United States
(12) Patent Application Publication
(10) Pub. No.: US 2015/0056972 A1
(43) Pub. Date: Feb. 26, 2015

(54) SYSTEM AND METHOD FOR COMMUNITY BASED MOBILE DEVICE PROFILING

(71) Applicant: International Business Machines Corporation, Armonk, NY (US)

(72) Inventors: Nicholas T. Bartlett, Chapel Hill, NC (US); Chelsea C. Beerse, Fairport, NY (US); David J. Claborn, Raleigh, NC (US); Jason C. Garcowski, Raleigh, NC (US); Andrew C. Latham, Overland Park, KS (US)

(73) Assignee: International Business Machines Corporation, Armonk, NY (US)

(21) Appl. No.: 13/972,065

(22) Filed: Aug. 21, 2013

(51) Int. Cl. H04M 1/725; H04W 4/16; H04W 4/02

(52) U.S. Cl. CPC H04M 1/72563; H04W 4/02; H04W 4/16
USPC 455/418

(57) ABSTRACT

A method, computer program product, and system is provided for community based mobile device profiling. In an implementation, a method may include receiving, via a first mobile device, a wireless signal associated with a second mobile device. The method may also include determining an identity of a user associated with the second mobile device. The method may further include establishing at least one setting of the first mobile device based upon, at least in part, a mobile device profile associated with the first mobile device and the identity of the user associated with the second mobile device.

### TECHNICAL FIELD

The present disclosure generally relates to mobile device profiling, and more particularly relates to systems and methods for community based mobile device profiling.

### BACKGROUND

Many individuals frequently carry a personal mobile device, which may allow various different types of communications with others. For example, cellular telephones may allow users to participate in mobile voice communications. Similarly, various different types of mobile computing devices may allow other types of mobile communications, such as email, instant messaging, video conferencing and the like. Mobile communications may often be facilitated by wireless connectivity using various different wireless protocols, such as cellular connectivity, WiFi connectivity, and the like. Mobile communications may often be useful in allowing individuals to easily remain in contact with one another, without having to remain in any particular fixed location.

### SUMMARY OF DISCLOSURE

According to an implementation, a method may include receiving, via a first mobile device, a wireless signal associated with a second mobile device. The method may also include determining an identity of a user associated with the second mobile device. The method may further include establishing at least one setting of the first mobile device based upon, at least in part, a mobile device profile associated with the first mobile device and the identity of the user associated with the second mobile device.

One or more of the following features may be included. The method may also include determining the identity of the user based upon, at least in part, the wireless signal. The identity of the user may also be determined based upon, at least in part, information stored within a data store. The identity of the user may include, at least in part, a user attribute.

The method may also include determining at least one setting of the second mobile device based upon, at least in part, a mobile device profile associated with the second mobile device.

The method may further include updating the mobile device profile associated with the first mobile device based upon, at least in part, a user input changing the at least one setting of the first mobile device and at least one previously established profile setting saved within the mobile device profile associated with the first mobile device.

The method may include changing the at least one setting of the first mobile device based upon, at least in part, the mobile device profile associated with the first mobile device and an incoming communication received at the first mobile device.

According to another implementation, a computer program product may include a non-transitory computer readable medium having a plurality of instructions stored on it. When executed by a processor, the instructions may cause the processor to perform operations including receiving, via a first mobile device, a wireless signal associated with a second mobile device. Instructions may also be included for determining an identity of a user associated with the second mobile device. Instructions may also be included for establishing at least one setting of the first mobile device based upon, at least in part, a mobile device profile associated with the first mobile device and the identity of the user associated with the second mobile device.

One or more of the following features may be included. Instructions may also be included for determining the identity of the user based upon, at least in part, the wireless signal. The identity of the user may also be determined based upon, at least in part, information stored within a data store. The identity of the user may include, at least in part, a user attribute.

Instructions may be included for determining at least one setting of the second mobile device based upon, at least in part, a mobile device profile associated with the second mobile device.

Instructions may also be included for updating the mobile device profile associated with the first mobile device based upon, at least in part, a user input changing the at least one setting of the first mobile device and at least one previously established profile setting saved within the mobile device profile associated with the first mobile device.

Instructions may also be included for changing the at least one setting of the first mobile device based upon, at least in part, the mobile device profile associated with the first mobile device and an incoming communication received at the first mobile device

According to yet another implementation, a system may include at least one processor device and at least one memory architecture coupled with the at least one processor device. The at least one processor device may be configured for receiving, via a first mobile device, a wireless signal associated with a second mobile device. The at least one processor may also be configured for determining an identity of a user associated with the second mobile device. The at least one processor may further be configured for establishing at least one setting of the first mobile device based upon, at least in part, a mobile device profile associated with the first mobile device and the identity of the user associated with the second mobile device.

One or more of the following features may be included. The at least one processor may be further configured for determining the identity of the user based upon, at least in part, the wireless signal. The identity of the user may include, at least in part, a user attribute.

The at least one processor may be further configured for determining at least one setting of the second mobile device based upon, at least in part, a mobile device profile associated with the second mobile device.

The at least one processor may be further configured for updating the mobile device profile associated with the first mobile device based upon, at least in part, a user input changing the at least one setting of the first mobile device and at least one previously established profile setting saved within the mobile device profile associated with the first mobile device.

The at least one processor may be further configured for changing the at least one setting of the first mobile device based upon, at least in part, the mobile device profile associated with the first mobile device and an incoming communication received at the first mobile device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a mobile device profile process according to an implementation of the present disclosure;

FIG. 2 is a flowchart of the mobile device profile process of FIG. 1, according to an implementation of the present disclosure;

FIG. 3 is a diagrammatic view of the computing device of FIG. 1, according to an implementation of the present disclosure.

Like reference symbols in the various drawings indicate like elements.

### DETAILED DESCRIPTION

Many individuals often carry a personal mobile device. Personal mobile devices may often be used by individuals to engage in, or at least allow for the possibility, of communicating with others, even when an individual is not at a fixed location, such as a home or office. Examples of personal mobile devices may include, but are not limited to, cellular telephones, smartphones, tablet computing devices, notebook or laptop computers, or the like. Such mobile devices may allow individuals to engage in and/or receive a variety of communications from others. For example, cellular telephone functionality and/or Voice-over-IP applications may facilitate voice communications. Similarly, video conferencing and/or video-over-IP applications may provide video communication, as well as audio communications. Some mobile devices may also provide synchronous (e.g., real-time and/or near real-time) and/or asynchronous communications. For example, some mobile devices may support instant messaging communications, email, text messaging (e.g., SMS communications), as well as multimedia messaging (e.g., MMS communications) as well as various other possible communication types.

According to some embodiments, the present disclosure may allow profile settings associated with mobile device to be, at least in part, dynamically controlled. For example, dynamically controlled profile settings for a mobile device may allow the mobile device to utilize different settings, such as alerts, availability status, or the like, in different situations. For example, if an individual is participating in an unscheduled meeting or discussion with others, the mobile device may dynamically adopt settings that may reduce and/or minimize any undesired interruptions. For example, dynamically adopting settings to reduce and/or minimize any undesired interruptions may prevent a ringer from a mobile device from disrupting an unscheduled meeting because the user did not have an opportunity to set the mobile device to silent or vibrate. In sensitive environments, a loud ringer or even a vibration may be a significant interruption to the function of a meeting, presentation, or gathering.

In some implementations, the present disclosure may allow at least some profile and/or settings of a mobile device to be dynamically controlled, e.g., in a manner that may not require a user input at the time of the dynamic control of the setting or profile. In this regard, the mobile device may automatically adopt a setting or profile based on a dynamically detected situation. In an example embodiment, a dynamically detected situation may be based on the presence of other people in proximity with the individual (e.g., within proximity of the mobile device that may be carried by the individual). In such an embodiment, upon detecting the presences of other people (e.g., particular individuals, a threshold number of individuals, make-up of a group of individuals, or the like), the mobile device may dynamically adopt a setting or profile. In some embodiments, the presence of other people may be determined based on wireless signals, e.g., which may be emitted by mobile device associated with the other people.

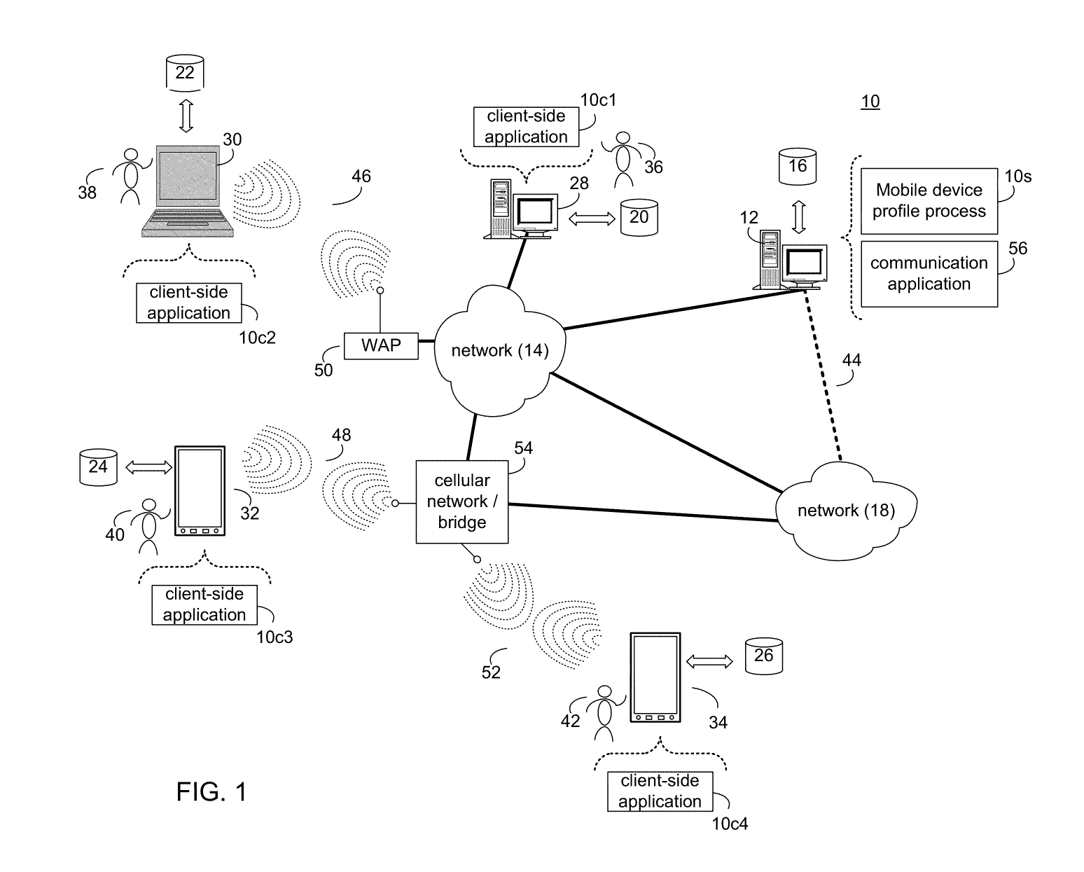

Referring to FIG. 1, there is shown mobile device profile process 10. For the following discussion, it is intended to be understood that mobile device profile process 10 may be implemented in a variety of ways. For example, mobile device profile process 10 may be implemented as a server-side process, a client-side process, or a server-side/client-side process.

For example, mobile device profile process 10 may be implemented as a purely server-side process via mobile device profile process 10s. Alternatively, mobile device profile process 10 may be implemented as a purely client-side process via one or more of client-side application 10c1, client-side application 10c2, client-side application 10c3, and client-side application 10c4. Alternatively still, mobile device profile process 10 may be implemented as a server-side/client-side process via mobile device profile process 10s in combination with one or more of client-side application 10c1, client-side application 10c2, client-side application 10c3, and client-side application 10c4. In such an example, at least a portion of the functionality of mobile device profile process 10 may be performed by mobile device profile process 10s and at least a portion of the functionality of mobile device profile process 10 may be performed by one or more of client-side application 10c1, 10c2, 10c3, and 10c4.

Accordingly, mobile device profile process 10 as used in this disclosure may include any combination of mobile device profile process 10s, client-side application 10c1, client-side application 10c2, client-side application 10c3, and client-side application 10c4.

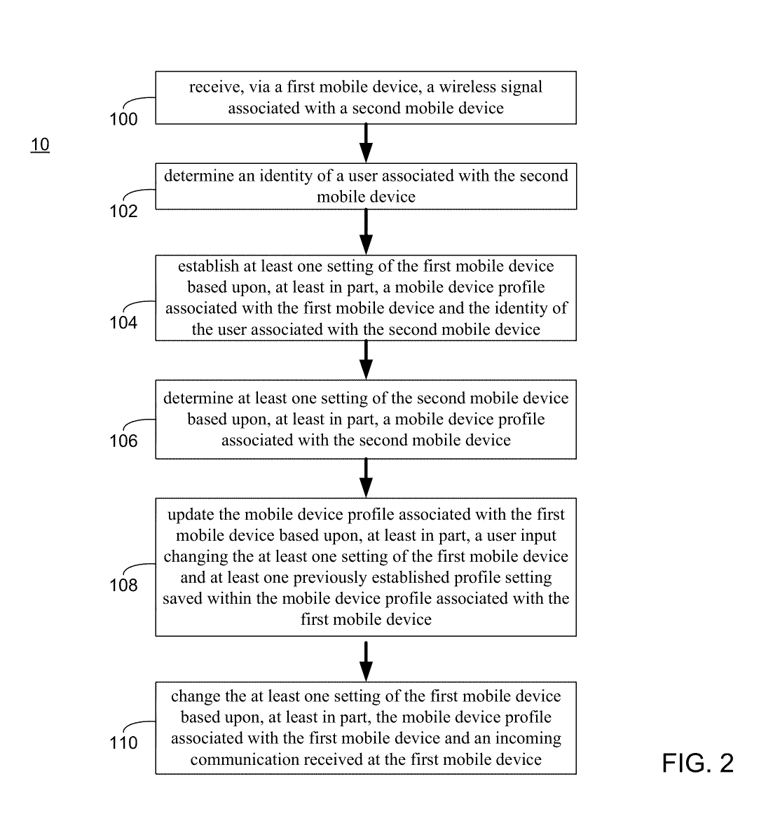

Referring also to FIG. 2, and as will be discussed in greater detail below, in an embodiment mobile device profile process 10 may receive 100, via a first mobile device, a wireless signal associated with a second mobile device. Mobile device profile process 10 may also determine 102 an identity of a user associated with the second mobile device. Mobile device profile process 10 may further establish 104 at least one setting of the first mobile device based upon, at least in part, a mobile device profile associated with the first mobile device and the identity of the user associated with the second mobile device.

Mobile device profile process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of mobile device profile process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include an application or process for implementing features and/or operations of mobile device profile process 10. For example, client-side applications 10c1, 10c2, 10c3, 10c4 may include and/or interact with an operating system of a mobile device. Additionally, in some embodiments client-side applications 10c1, 10c2, 10c3, 10c4 may include, but are not limited to, client-side communication applications. Examples of such client-side communication applications may include, but are not limited to, a mobile communication telephony application or process, a voice over IP application, a video over IP application, a soft-phone application, a video conferencing application, an email application, an instant messaging application, a web browser, or a specialized application (e.g., an application running on a mobile platform). Additionally/alternatively, mobile device profile process 10 may interact and/or communicate with one or more communication applications. The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, personal computer 28, laptop computer 30, mobile computing device 32, smart phone 34, a tablet computing device (not shown), a netbook computer (not shown), a server computer (not shown), a gaming console (not shown), a data-enabled television console (not shown), and a dedicated network device (not shown). Client electronic devices 28, 30, 32, 34 may each execute an operating system.

Users 36, 38, 40, 42 may access mobile device profile process 10 directly on respective client electronic devices 28, 30, 32, 34, and/or through network 14 or through secondary network 18. Further, mobile device profile process 10 may be accessed through secondary network 18 via link line 44.

The various client electronic devices (e.g., client electronic devices 28, 30, 32, 34) may be directly or indirectly coupled to network 14 (or network 18). For example, personal computer 28 is shown directly coupled to network 14. Further, laptop computer 30 is shown wirelessly coupled to network 14 via wireless communication channel 46 established between laptop computer 30 and wireless access point (WAP) 50. Similarly, mobile computing device 32 is shown wirelessly coupled to network 14 via wireless communication channel 48 established between mobile computing device 32 and cellular network/bridge 54, which is shown directly coupled to network 14 and network 18. WAP 50 may be, for example, an IEEE 802.11a, 802.11b, 802.11g, 802.11n, Wi-Fi, Bluetooth, and/or ANT device that is capable of establishing wireless communication channel 46 between laptop computer 30 and WAP 50. Additionally, smart phone 34 is shown wirelessly coupled to network 14 via wireless communication channel 52 established between smart phone 34 and cellular network/bridge 54, which is shown directly coupled to network 14 and network 18.

In some embodiments, mobile device profile process 10 may communicate with, interact with, and/or include a component or module of a communication application (e.g., communication application 56). As is generally known, a communication application (e.g., communication application 56) may generally facilitate communications between multiple parties. For example, communication application 56 may facilitate voice over IP and/or video over IP communications between a plurality of users. In some embodiments, communication application may include, and/or may interact with, for example, a mobile communication telephony application, a voice over IP application, a video over IP application, a soft-phone application, a video conferencing application, an email application, an instant messaging application, a web browser, or a specialized application (e.g., an application running on a mobile platform).

In an embodiment, the instruction sets and subroutines of communication application 56 may be stored, e.g., on storage device 16 associated with server computer 12, which executes communication application 56, and/or another suitable storage device. Further, users (e.g., one or more of users 36, 38, 40, 42) may access communication application 56 in order to participate in a communication session. The users may access communication application 56 via one or more suitable applications, such as client side applications 10c1-10c4 (e.g., which may include a mobile communication telephony application, a voice over IP application, a video over IP application, a soft-phone application, a video conferencing application, an email application, an instant messaging application, or a web browser) and/or via a different application (not shown). As generally discussed above, a portion and/or all of the functionality of mobile device profile process 10 may be provided by one or more of client side applications 10c1-10c4. For example, in some embodiments mobile device profile process 10 (and/or client-side functionality of mobile device profile process 10) may be included within and/or interactive with client-side applications 10c1-10c4, which may include client side communication applications, web browsers, or another application. Various additional/alternative configurations may be equally utilized.

As generally discussed above with reference to FIG. 2, in an embodiment mobile device profile process 10 may receive 100, via a first mobile device, a wireless signal associated with a second mobile device. Mobile device profile process 10 may also determine 102 an identity of a user associated with the second mobile device. Mobile device profile process 10 may further establish 104 at least one setting of the first mobile device based upon, at least in part, a mobile device profile associated with the first mobile device and the identity of the user associated with the second mobile device.

For the purpose of the following description, smart phone 34 may be described. However the description of smart phone 34 is intended for the purpose of illustration only. In various embodiments, the first mobile device may include another mobile device, such as a tablet computing device, a notebook computer, and/or any other mobile computing device having wireless capabilities.

In an embodiment mobile device profile process 10 may receive 100, via a first mobile device, a wireless signal associated with a second mobile device. For example, mobile device profile process 10 may receive, via smart phone 34, wireless signals from one or more other mobile devices that may be within proximity of smart phone 34 (i.e., proximity based on a range characteristic of the wireless signal). As generally discussed above, people may often carry various mobile devices with them. Examples of mobile devices may include, but are not limited to, cell phones, smart phones, tablet computing devices, laptop computers, netbook computers, and/or any other mobile computing devices having wireless capabilities. Such mobile devices may emit various wireless signals, for example, continuously, intermittently, and/or in response to a received request. Examples of wireless signals may include, but are not limited to, WiFi, Bluetooth, ANT, Near Field Communication (NFC) signal, and the like. For example, a mobile device may transmit a Bluetooth wireless signal as part of a communication with a paired device, and/or for the purpose of discovering/being discovered by other Bluetooth capable devices. Such transmissions may occur automatically, in response to a received signal from another device, and/or in response to a user action. Similarly, mobile device may transmit WiFi wireless signals and/or may respond to received WiFi, e.g., for the purpose of establishing wireless connections with various device.

In an illustrative example, user 42 (e.g., a user who may be in possession of smart phone 34) may be in physical proximity with one or more other users who may similarly be in possession of other mobile devices. For example, user 42 may encounter user 40 (in possession of mobile computing device 32), user 38 (in possession of notebook computer 30) and Susan (e.g., who may also be in possession of a smart phone) and may engage in a discussion or impromptu meeting, and/or other interaction. One or more of mobile computing device 32, notebook computer 30 and Susan's smart phone may transmit one or more different wireless signal. The one or more different signals may be transmitted based on various operations of the mobile computing device 32, notebook computer 30, and Susan's smartphone, such as communications with other devices, broadcasts for the purpose of discovering available networks and/or device that may be communicated with, and/or may be otherwise transmitted. In some situations, the various mobile devices (e.g., one or more of mobile computing device 32, notebook computer 30, and Susan's smart phone) may transmit wireless signals in response to one or more wireless signals received from smart phone 34 (e.g., which may be transmitted in an attempt to discover available wireless networks, available device to communicate with, and/or in an attempt to identity surrounding devices) and/or in response to an input from user 40. Mobile device profile process 10 may receive 100, via the first mobile device, any number of wireless signals from any number of mobile devices. For example, and continuing with the above illustrative example, mobile device profile process 10 may receive 100, via smart phone, wireless signals (e.g., Bluetooth signals, WiFi signals, etc.,) from one or more of mobile computing device 32, notebook computer 30, and Susan's smart phone. In some embodiments, mobile device profile process 10 may receive 100, via the first mobile device, wireless signals from other mobile devices based on a degree of proximity (e.g., which may be inferred based on signal strength, signal type, and/or other criterion).

Mobile device profile process 10 may also determine 102 an identity of a user associated with the second mobile device. Mobile device profile process 10 may receive 100, via the first mobile device, nearby wireless signals and gather information from the received 100 wireless signals. In some embodiments, mobile device profile process 10 may determine 102 the identity of the user based upon, at least in part, the received wireless signal. Continuing with the above-example in which mobile device profile process 10 may receive 100, via smart phone 34, one or more wireless signals from mobile computing device 32, notebook computer 30, and Susan's smart phone, mobile device profile process 10 may identify the device transmitting each of the received wireless signals. Further, mobile device profile process 10 may also identify a user associated with each of the devices transmitting a received signal. In an embodiment, based upon information included in the received 100 wireless signal from second mobile device (e.g., one or more of mobile computing device 32, notebook computer 30, and/or Susan's smart phone), mobile device profile process 10 may determine 102 the identity of the user associated with the second mobile device. The information included in the received 100 wireless signal may include, for example, a device identifier (e.g., a Bluetooth device address, a network card ID, a device name, and/or other identifying information that may be transmitted via the received 100 wireless signal). In some embodiments, the information may allow mobile device profile process 10 to determine 102 one or more of an identity of the second mobile device and/or a user of the second mobile device.

The identity of the user associated with the second mobile device may also be determined 102 based upon, at least in part, information stored within a data store. For example, as generally discussed above, the received 100 wireless signal may include various information. In some embodiments, the information included in the received 100 wireless signal may include a device identification, a network card ID, and/or other identifying information associated with the second mobile device. In some implementations, the information may not directly identify the user of the second mobile device. Accordingly, in some embodiments, mobile device profile process 10 may access a data store, and may determine 102 an identity of a user associated with the second mobile device based on, at least in part, the information within the data store. In various implementations, the data store may be maintained on the first mobile device (e.g., storage device 26 of smart phone 34 in the forgoing example) via which the wireless signal is received, and/or may be maintained on another device (e.g., storage device 16 associated with computing device 12, and or on another storage device associated with another computing device).

Examples of a data store may include, but are not limited to, a list, a database, a directory, a corporate directory (such as an LDAP directory), and/or any type of collection of data. Information included within the data store may include, but is not limited to, the wireless signal associated with a mobile device, a name of the user associated with the mobile device, contact information for the user associated with the mobile device, such as phone number, email, and/or the like, and any other identifying information of the user associated with the mobile device. An example of information stored within a corporate LDAP directory may include, but is not limited to, device network card ID, a Bluetooth device address, a device name, and/or other information that may be included within the received 100 wireless signal, a name of the user associated with the mobile device, contact information for the user associated with the mobile device, relative hierarchical information for the user associated with the mobile device, and any other information included within a corporate directory. Examples of relative hierarchical information may include, but are not limited to, a title of the user, a rank of the user, a pay grade of the user, and/or other information denoting relative hierarchical status of the user. As discussed in greater detail below, changes in a corporate structure may be reflected in the corporate LDAP directory, which may be used to determine 102 the identity the user associated with the second mobile device.

Determining 102 an identity of the user associated with the second mobile device based on, at least in part, information stored within a data store may include executing a query on the data store for user identity information correlated to information included within the received 100 wireless signal. Continuing with the above example, when user 34 (operating smart phone 34) is in proximity with user 40 (operating mobile device 32), user 38 (operating notebook computer 30) and Susan (operating Susan's smart phone), for example, as the result of an impromptu hallway meeting, mobile device profile process 10 may receive 100, via smart phone 34, a wireless signal from each of mobile device 32, notebook computer 30, and Susan's smartphone. For example, information included within each wireless signal may include, for example, a network card ID, a device name, a Bluetooth device identifier, or other information that may be identifying information associated with the device from which the wireless signal is received. Mobile device profile process 10 (alone and/or in conjunction with one or more other applications or processes) may execute a query on the data store based on the information associated with each of mobile device 30, notebook computer 28, and Susan's smart phone. The query may return search results relative to each piece of identifying information, such as an identification of the device operator (e.g., user 40, user 38, and Susan respectively), contact information associated with each device operator, hierarchical information associated with each device operator, and the like. As such, mobile device profile process 10 may determine 102 the identity of one or more of the users of the one or more mobile devices from which a wireless signal is received.

In an embodiment, mobile device profile process 10 may determine 102 the identity of the user associated with the second mobile device including, at least in part, a user attribute. Examples of user attributes may include, but are not limited to, a particular user, a rank of a user, a relative hierarchical status of a user, a group of users, and the like. For example, mobile device profile process 10 may determine 102 (e.g., based upon, at least in part, information included within the data store, or via another mechanism) that user 40, associated with mobile computing device 32, may be a supervisor of user 42, associated with smart phone 34. Similarly, user 42 may be a manager overseeing a team of developers. Mobile device profile process 10 may determine 102 (e.g., based on a query executed on the data store, or other suitable mechanism) that the identity of user 38, associated with notebook computer 30, may be a team member of the development team which user 42 leads. Further, mobile device profile process 10 may also determine 102 that Susan, the operator of Susan's smart phone, is a particular colleague of user 42. Various additional and/or alternative user attributes may similarly be determined for a user of the second mobile device.

In an example embodiment, mobile device profile process 10 may determine at least one current setting of the first mobile device. Settings of a mobile device may include, but are not limited to, an on state, an off state, a sleep mode, an airplane mode, a ringer mode, and the like. Examples of ringer modes may include, but are not limited to, silent, vibrate, and ringtone type, ring tone volume, etc. The ringtone of a mobile device may be adjusted to any ringtone and/or volume permitted by the mobile device. Further, different settings may be applied to different modes. For example, the first mobile device (e.g., smart phone 34) may interact with communication applications 56 to provide one, or a variety, of communication types, such as voice calls, video conferencing, email, instant messaging, etc. Various different settings may be associated with one or more of the various communication modes. For example, settings associated with one or more of the communication modes may include notification settings. For example, a first audible alert (ring tone) may be associated with receiving an instant messaging communications, and a different audible alert (e.g., a different ring tone) may be associated with receiving an email message, The various settings of the first mobile device may be set based on default settings, user preferences, administrative policies, or the like. For example, user 42 may set smart phone 34 to vibrate for all communication modes. In such an embodiment, in response to an incoming communication (e.g., an incoming telephone call, instant messaging message, email message, or the like) being received by smart phone 34, smart phone 34 may provide a vibrating alert, to indicate to user 42 that an incoming communication has been/is being received. Consistent with the foregoing example, mobile device profile process 10 may determine the current setting of first mobile device is set to vibrate for all incoming communications. If user 42 changes the setting of first mobile device to silent for all incoming communications, mobile device profile process 10 may determine that the setting of first mobile device has changed from vibrate to silent for all incoming communications. Mobile device profile process 10 may determine various alternative setting configurations and/or changes.

Mobile device profile process 10 may further establish 104 at least one setting of the first mobile device based upon, at least in part, a mobile device profile associated with the first mobile device and the identity of the user associated with the second mobile device. A mobile device profile may include defined settings and/or preferences for the at least one setting of the mobile device that may be utilized in a defined situation. As such, the mobile device profile may allow the mobile device to perform differently in different situations. For example, the mobile device profile may define a “general profile” in which alerts for incoming communications may include an audible alert (and/or a different audible alter for different communication types) at a moderate volume. Similarly, the mobile device profile may define a “discrete profile” in which alerts for incoming communications may include a vibrating alert (and/or vibrating alerts having different vibration patterns for different communication types). The example mobile device profile may also define a “silent profile” in which no alert may be provided for incoming communications. The mobile device profile may include various additional and/or alternative profiles having various different settings. In some embodiments, a single and/or similar mobile device profile may be utilized in connection with more than one mobile device. As generally described above, the mobile device profile may include any number of defined settings and/or preferences. The defined settings and/or preferences may be defined by a particular user, may be defined based on one or more rules, and/or may include default profile settings.

As discussed above, mobile device profile process 10 may establish 104 at least one setting of the first mobile device based upon, at least in part, a mobile device profile associated with the first mobile device and the identity of the user associated with the second mobile device. For example, a mobile device profile associated with smart phone 34 may define a preference to automatically set smart phone 34 to vibrate (e.g., the “discrete profile”) when mobile device profile process 10 receives 100, via smart phone 34, any other wireless signal within proximity of smart phone 34 (i.e., proximity based on the range characteristic of the wireless signal). Further, the mobile device profile associated with smart phone 34 may define a preference to automatically set smart phone to a moderate ring tone volume (e.g., the “general profile”) if no other wireless signals are received 100. According to such an example, in a situation in which mobile device profile process 10 does not receive 100 any wireless signals from any other mobile devices, mobile device profile process 10 may establish 104 the “general profile,” in which an audible alert of moderate volume may be utilized for all incoming communications. Further, in response to receiving 100, via smart phone 34, a wireless signal from a second mobile device, mobile device profile process 10 may establish 104 the “discrete profile,” whereby a vibrating alert may be utilized as a notification of incoming communications.

In an example embodiment, a mobile device profile associated with smart phone 34, and/or with user 42, may define a preference to set the first mobile device to vibrate when the first mobile device receives 100 a wireless signal associated the user's office or a user's client, and otherwise to set the first mobile device to a specific ringtone. Consistent with such an example, mobile device profile process 10 may receive 100 a wireless signal from a second mobile device (e.g., from notebook computer 30, operated by user 38 who may be a member of a team supervised by user 42). In response to receiving the wireless signal from notebook computer 30, mobile device profile process 10 may determine 102 an identity of the user associated with notebook computer 30 (i.e., user 38, who may be a member of a team supervised by user 42). For example, mobile device profile process 10 may determine the identity of user 38 based upon, at least in part, information included within the wireless signal, based upon, at least in part, information included within a data store (e.g., which may correlate characteristics of the wireless signal, such as a device ID, with the identity of user 38). Further, based upon, at least in part, the identity of user 38 associated with notebook computer 30, and the preference to set smart phone to vibrate when a signal associated with user 42's office is received 100, mobile device profile process 10 may establish at least one setting of smart phone 34 such that a vibrating alert may be utilized to indicate an incoming communication (e.g., such as an incoming telephone call, an incoming email, etc.).

In an example embodiment, user 42 associated with smart phone 34 may define a preference to set the first mobile device to silent when mobile device profile process 10 receives 100, via smart phone 34, a large number of wireless signals within proximity of smart phone 34 (i.e., proximity based on the range characteristic of the wireless signal). Accordingly, responsive to receiving 100 a large number of wireless signals (e.g., in which the large number of wireless signals may be defined based on a threshold number of wireless signals, or the like), mobile device profile process 10 may establish 104 at least one setting of smart phone 34, such that smart phone may provide a silent alert to a received and/or incoming communication. Alternatively/additionally, user 42 associated with smart phone 34 may define a preference to set smart phone 34 to a loud ringtone when mobile device profile 10 receives 100 a large number of wireless signals within proximity (i.e., proximity based on the range characteristic of the wireless signal) and it is determined from at least one wireless signal received 100 that smart phone 34 is within proximity of an event venue, such as a sports game, concert, or the like (e.g., based upon, at least in part, a signal characteristic, information included within the signal, etc.). In a generally similar manner as discussed above, in response to receiving 100 a large number of wireless signals, in which at least one wireless signal is within proximity of an event venue, mobile device profile process 10 may establish 104 at least one setting of smart phone 34 to provide a loud ringtone notification for incoming communications.

In an illustrative example, user 42 may be the president of a small company. Unscheduled meetings may occur throughout the day which may require user 42's attention. User 42 may not want to be disturbed while meeting with specific team members. As such, user 42 may define a mobile device profile associated with smart phone 34 to set the ringer of smart phone 34 to silent for incoming telephone calls and to set e-mail notifications of smart phone 34 to vibrate for received email messages when mobile device profile process 10 receives 100, via smart phone 34, a wireless signal from three defined vice presidents. Furthering this example, user 42 may be stopped for an unscheduled discussion with two employees, and mobile device profile process 10 may receive 100, via smart phone 34, wireless signals from mobile devices associated with the two employees. In response to receiving 100 wireless signals from the mobile devices associated with the two respective employees, mobile device profile process 10 may determine 102 the identities of the users associated with the two mobile devices. For example, mobile device profile process 10 may determine 102 the identities of the users associated with the two mobile devices based upon, at least in part, a corporate LDAP directory. For example, the received 100 wireless signals from the mobiles devices associated with the two employees may include characteristics and/or information (e.g., device ID's, etc.) which may be correlated with the identities of the two employees within a corporate LDAP directory. Based upon, at least in part, the corporate LDAP directory, mobile device profile process 10 may determine 102 that the identity of the two employees include one vice president and one manager. Because the two employees do not satisfy the criteria in the defined preferences of the mobile device profile associated with user 42 (namely wireless signals are not received from any of the three defined vice presidents), mobile device profile process 10 may establish 104 the at least one setting associated with smart phone 34 associated with user 42 and may not change or update settings associated with smart phone 34.

Furthering the above example, user 42 may be stopped for an impromptu meeting by three individuals. Mobile device profile process 10 may receive 100, via smart phone 34, wireless signals from any mobile devices in proximity of smart phone 43 (e.g., which may include wireless signals from mobile devices associated with each of the three employees involved in the impromptu meeting). Mobile device profile process 10 may determine 102 the identities of the users associated with their respective mobile devices as described above (e.g., based upon, at least in part, a corporate LDAP directory, and/or other described methodology). Mobile device profile process 10 may determine 102 (e.g., based on the received 100 wireless signals) that at least three of the mobile devices within proximity of smart phone 34 are associated with the three defined vice presidents within the mobile device profile. Based upon, at least in part, the mobile device profile associated with smart phone 34, mobile device profile process 10 may establish 104 at least one setting of smart phone 34 to provide a silent alert for incoming telephone calls and a vibrating alert for received email messages, e.g., as the criteria of the mobile device profile may be satisfied (e.g., smart phone 34 was within proximity of the three vice presidents defined in the mobile device profile associated with smart phone 34).

In an embodiment, mobile device profile process 10 may also determine 106 at least one setting of a second mobile device based upon, at least in part, a mobile device profile associated with the second mobile device. As described above, mobile device profile process 10 may receive 100, via the first mobile device (e.g., smart phone 34), a wireless signal from a second mobile device (e.g., a tablet computing device, not shown). Based on the mobile device profile associated with the second mobile device, mobile device profile process 10 may determine 106 the defined preferences and/or settings associated with the second mobile device. In some embodiments, mobile device profile process 10 may apply those settings to the first mobile device. For example, user 42 may be a junior developer. The mobile device profile associated with smart phone 34 operated by user 42 may include a preference to mimic the settings of mobile devices associated with senior developers when smart phone 34 is within proximity of mobile devices associated with senior developers. For example, mobile device profile process 10 may receive 100, via smart phone 34, wireless signals from any mobile devices within proximity of user 42. In response to receiving 100 the wireless signal(s), mobile device profile process 10 may determine 102 the identities of the users associated with the mobile devices from which the wireless signal(s) are received (e.g., in a manner as generally described above, such as based upon, at least in part, information included within the wireless signals, based upon, at least in part, information within a data store, or the like). In response to determining 102 that an identity of at least one user associated with a mobile device within proximity of user 42 is a senior developer, mobile device profile process 10 may determine 106 at least one setting of the mobile device associated with the senior developer. For example, mobile device profile process 10 may determine 106 at least one setting of the mobile device associated with the senior developer based upon, at least in part, the mobile device profile associated with the mobile device associated with the senior developer. For example, a data store may include information regarding mobile device profiles associated with users of mobile devices, and/or associated with mobile devices alone. In such an embodiment, mobile device profile process 10 may determine 106 at least one setting of the mobile device associated with the senior developer including accessing a data store that may correlate user identity and/or mobile device identity with associated mobile device profiles. In an embodiment, the data store may include a corporate LDAP directory. For example, in addition/as an alternative to correlating wireless signal characteristic and/or mobile device characteristics (such as mobile device identifiers, network card ID's, etc.) with individual users, an LDAP directory may correlate mobile device profiles (e.g., which may include one or more mobile device settings) with individuals and/or mobile devices associated with individuals. Based upon the defined preferences within mobile device profile associated with first mobile device, mobile device profile process 10 may mimic at least one setting associated with the mobile device associated with the senior developer. That is, for example, mobile device profile process 10 may copy at least one setting associated with the mobile device associated with the senior developer.

Mobile device profile process 10 may automatically save the determined 106 at least one setting associated with the mobile device associated with the senior developer to the mobile device profile associated with smart phone 34 associated with user 42. Mobile device profile process 10 may further automatically apply the determined 106 at least one setting associated with the mobile device associated with the senior developer to smart phone 34 associated with user 42. For example, mobile device profile process 10 may establish 104 at least one setting of smart phone 34 based upon, at least in part, the determined 102 identity of the senior developer and based upon, at least in part, a mobile device profile associated with smart phone 34 (which may now include the at least one setting from the mobile device profile associated with the senior developer). In an embodiment, determining 106 the at least one setting of the second mobile device may also include determining 106 the current settings of the second mobile device associated with the senior developer. Consistent with the foregoing, in an embodiment, mobile device profile process 10 may allow mobile device profiles associated with other users/mobile devices to be adopted by the first mobile device/the operator of the first mobile device. As such, for example, a user who is unsure of the appropriate mobile device profile or settings to adopt in a given situation may relay on the experience of others, and adopt common settings. As such, the device profile for the first user may dynamically evolve over time.

In an embodiment, mobile device profile process 10 may update 108 the mobile device profile associated with the first mobile device based upon, at least in part, a user input changing the at least one setting of the first mobile device and at least one previously established profile setting saved within the mobile device profile associated with the first mobile device. For example, user 42 may be stopped in a hallway to discuss a project by a peer colleague in an impromptu meeting. User 42 may manually change at least one setting of the first mobile device (e.g., smart phone 34) from a loud ringtone to a soft ringtone. Mobile device profile process 10 may determine 102 the identity of the peer colleague from a wireless signal received 100 from a second mobile device associated with the peer colleague, in a manner a generally discussed above. Mobile device profile process 10 may update 108 the mobile device profile associated with smart phone 34 associated with user 42 to reflect that when smart phone 34 is within proximity of a peer colleague (or any particular user or rank of users), mobile device profile process may establish 104 at least one setting of smart phone 34 to provide a soft ringtone. In such an embodiment, mobile device profile process 10 may allow a mobile device process (and/or one or more settings included within a mobile device process) to be updated or changed, such that the updated or changed profile (and/or one or more settings within the profile) may be utilized in future encounters with the relevant individuals and/or in the relevant situations.

In an embodiment, mobile device profile process 10 may store one or more wireless signals received 100 within a period of time. For example, user 42 may be stopped in a hallway to discuss a project by a peer colleague. When the discussion is complete, user 42 may update mobile device profile to define that in the last 10 minutes, the first mobile device (e.g., smart phone 34) associated with user 42 should have been set to a soft ringtone. Mobile device profile process 10 may determine 102 the identities of the users associated with the one or more wireless signals received 100 from the surrounding mobile devices and learn to automatically update 108 the mobile device profile associated with smart phone 34 associated with user 42 over time. In such an embodiment, mobile device profile process 10 may facilitate tailoring a mobile device profile (and/or one or more settings of a mobile device profile) to achieve user desired performance. In an example, by storing the one or more wireless signals received 100 within a defined period of time, a user may more easily tailor the mobile device profile and/or the one or more settings of the profile. For example, rather than manually inputting an identity of the relevant individuals and defining a corresponding setting, the user of the first mobile device may simply indicate that during, for example, the last 10 minutes, it would have been desirable to have one or more established settings for the first mobile device (e.g., to establish a setting in which the ringer of the mobile device was turned off, etc.). Based on such an indication received from the user, mobile device profile process 10 may identify the relevant situation, e.g., based on the received 100 wireless signals and/or identified 102 individuals, corresponding to the situation. Mobile device profile process 10 may further modify the mobile device profile (and/or one or more settings within the mobile device profile) associated with the first mobile device. As such, in subsequent corresponding situations (e.g., subsequent situations involving the same mobile devices and/or users of mobile devices) mobile device profile process 10 may apply the user indicated mobile device profile (and/or settings within the mobile device profile).

In an embodiment, mobile device profile process 10 may change 110 the at least one setting of the first mobile device based upon, at least in part, the mobile device profile associated with the first mobile device and an incoming communication received at the first mobile device. For example, a mobile device profile associated with the first mobile device (e.g., smart phone 34) may include exceptions to the defined preferences and/or settings, and/or different defined preferences and/or settings for different circumstances. For example, based on one or more preferences defined within mobile device profile associated with the first mobile device, mobile device profile process 10 may establish 104 settings for the first mobile device to provide a vibrating alert when mobile device profile process 10 receives 100, via the first mobile device, a wireless signal that is determined 102 that the identity of a user associated with the received 100 wireless signal is associated with a place of employment of the first user. Exceptions may be defined, for example, for certain incoming communication types, communication sources, or the like. For example, an exception to the mobile device profile may be defined for e-mail received at the first mobile device from the first user's boss, calls received at the first mobile device from the first user's family member, etc. Mobile device profile process 10 may temporarily change 110 the one or more setting of the first mobile device to a ringtone or alert specified by the exception for e-mail received from the first user's boss and/or a call received from the user's family member.

In an embodiment, mobile device profile process 10 may receive 100, via the first mobile device (e.g., smart phone 34), numerous wireless signals from numerous mobile devices within proximity of the first mobile device. A mobile device profile associated with the first mobile device may include preferences of importance for the defined settings included within mobile device profile. For example, the defined preferences and/or settings included within mobile device profile may conflict based upon, at least in part, the determined 102 identities of the users associated with the other mobile devices. For example, mobile device profile process 10 may receive 100, via the first mobile device, wireless signals associated with three other mobile devices within proximity of first mobile device. Mobile device profile process 10 may determine 102 the identities of the users associated with the three other mobile devices. Based upon the mobile device profile associated with first mobile device, mobile device profile process 10 may determine that three different settings are defined for the three different identified users. Mobile device profile process 10 may determine which setting to establish 104 for the first mobile device based upon, at least in part, the preferences of importance for the defined settings included within mobile device profile associated with first mobile device.

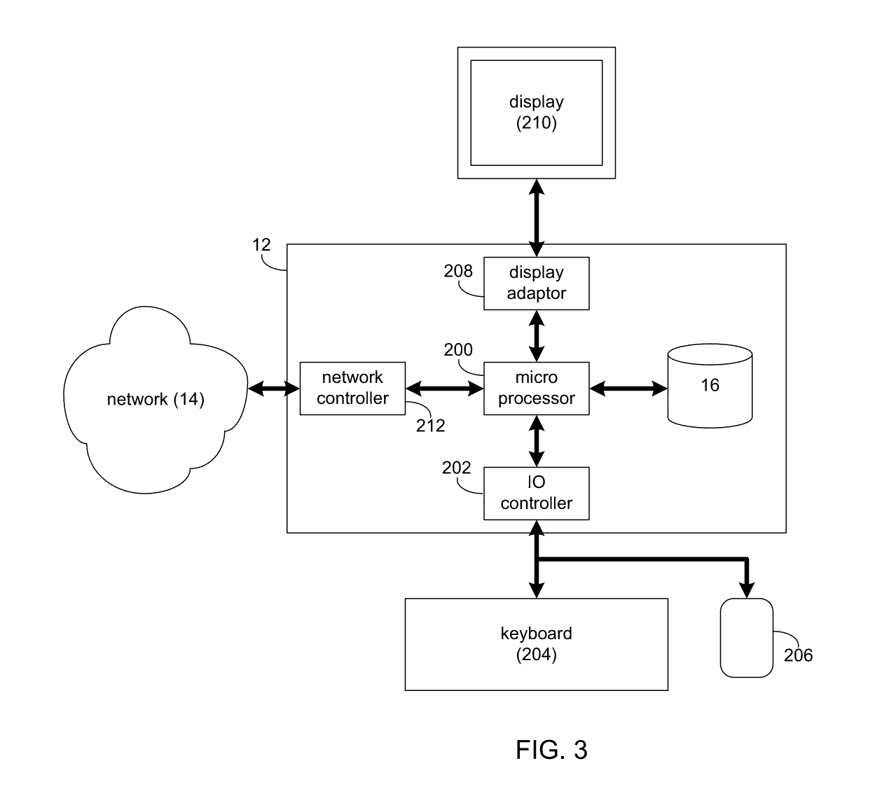

Referring also to FIG. 3, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, mobile device profile process 10 may be substituted for computing device 12 within FIG. 3, examples of which may include but are not limited to client electronic devices 28, 30, 32, 34.

Computing system 12 may include microprocessor 200 configured to e.g., process data and execute instructions/code for screen capture process 10. Microprocessor 200 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 202 may be configured to couple microprocessor 200 with various devices, such as keyboard 204, mouse 206, USB ports (not shown), and printer ports (not shown). Display adaptor 208 may be configured to couple display 210 (e.g., a CRT or LCD monitor) with microprocessor 200, while network adapter 212 (e.g., an Ethernet adapter) may be configured to couple microprocessor 200 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, C#.NET, PHP, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 200) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1.-7. (canceled)

8. A computer program product comprising a non-transitory computer readable medium having a plurality of instructions stored thereon, which, when executed by a processor, cause the processor to perform operations including:
receiving, via a first mobile device, a wireless signal associated with a second mobile device;
determining an identity of a user associated with the second mobile device; and
establishing at least one setting of the first mobile device based upon, at least in part, a mobile device profile associated with the first mobile device and the identity of the user associated with the second mobile device.

9. The computer program product of claim 8, wherein the identity of the user is determined based upon, at least in part, the wireless signal.

10. The computer program product of claim 8, wherein the identity of the user is determined based upon, at least in part, information included within a data store.

11. The computer program product of claim 8, wherein the identity of the user includes, at least in part, a user attribute.

12. The computer program product of claim 8, further including instructions for:
determining at least one setting of the second mobile device based upon, at least in part, a mobile device profile associated with the second mobile device.

13. The computer program product of claim 8, further including instructions for:
updating the mobile device profile associated with the first mobile device based upon, at least in part, a user input changing the at least one setting of the first mobile device and at least one previously established profile setting saved within the mobile device profile associated with the first mobile device.

14. The computer program product of claim 8, further including instructions for:
changing the at least one setting of the first mobile device based upon, at least in part, the mobile device profile associated with the first mobile device and an incoming communication received at the first mobile device.

15. A system comprising:
at least one processor device and at least one memory architecture coupled with the at least one processor device, the at least one processor device configured for:
receiving, via a first mobile device, a wireless signal associated with a second mobile device;
determining an identity of a user associated with the second mobile device; and
establishing at least one setting of the first mobile device based upon, at least in part, a mobile device profile associated with the first mobile device and the identity of the user associated with the second mobile device.

16. The system of claim 15, wherein the identity of the user is determined based upon, at least in part, the wireless signal.

17. The system of claim 15, wherein the identity of the user includes, at least in part, a user attribute.

18. The system of claim 15, the at least one processor further configured for:
determining at least one setting of the second mobile device based upon, at least in part, a mobile device profile associated with the second mobile device.

19. The system of claim 15, the at least one processor further configured for:
updating the mobile device profile associated with the first mobile device based upon, at least in part, a user input changing the at least one setting of the first mobile device and at least one previously established profile setting saved within the mobile device profile associated with the first mobile device.

20. The system of claim 15, the at least one processor further configured for:
changing the at least one setting of the first mobile device based upon, at least in part, the mobile device profile associated with the first mobile device and an incoming communication received at the first mobile device.
